(19) United States
(12) Patent Application Publication
(10) Pub. No.: US 2025/0211518 A1
(43) Pub. Date: Jun. 26, 2025

(54) HARDWARE-BASED AND EFFICIENT FORWARDING OF DATA

(71) Applicant: INOVA SEMICONDUCTORS GMBH, Munich (DE)

(72) Inventors: Roland NEUMANN, Bad Toelz (DE); Fabian KLUGE, Perasdorf (DE)

(21) Appl. No.: 19/076,626

(22) Filed: Mar. 11, 2025

Related U.S. Application Data
(63) Continuation of application No. PCT/EP2023/059296, filed on Apr. 6, 2023.

(30) Foreign Application Priority Data
Sep. 27, 2022 (EP) 22198219.2

(51) Int. Cl. H04L 45/24; H04L 69/22

(52) U.S. Cl. CPC H04L 45/24; H04L 69/22

(57) ABSTRACT

A transmission device is provided for efficiently forwarding data in an automobile, which allows for example 128 virtual data paths to be able to efficiently transmit data on a single physical channel. The device is unidirectional and may be provided with low technical outlay. The device is designed for reduced weight and high fault tolerance. The weight saving is by simplifying conventional units, to which end only a single physical path is necessary, but the devices are able to handle 128 virtual data paths. Robustness against faults is achieved in that the structural components are unidirectional, and are provided in simple form and without structural features susceptible to faults. Also provided is an input device and a system arrangement comprising the proposed transmission device and a proposed reception device. Also proposed is a method for utilizing such a transmission device and system.

### CROSS REFERENCE TO RELATED APPLICATIONS

This application is a continuation of International Application No. PCT/EP2023/059296, filed on Apr. 6, 2023, which takes priority from European Application No. 22198219.2, filed on Sep. 27, 2022 the entire contents of each of which are incorporated by reference herein.

### TECHNICAL FIELD

The present invention is directed to a transmission device for the efficient forwarding of data in an automobile, which enables data to be transmitted efficiently on a single physical channel, for example 128 virtual data paths. The proposed invention creates devices which are unidirectional and can thus be provided with low technical effort due to the reduced complexity. The present invention is particularly focused on the requirements in an automobile, where weight reduction and high fault tolerance are necessary. The weight saving is achieved by the simplification of conventional units, where only a single physical path is required, but the devices can handle 128 virtual data paths. Fault robustness is achieved in accordance with embodiments of the invention by making the structural components unidirectional and thus they can be created particularly easily and without error-prone structural features. The invention is further directed to an input device in the transmitting direction, which is partially functionally inverse to the output device in the receiving direction, and a packet data processing device in the transmitting direction and in the receiving direction, as well as to a system arrangement comprising the proposed transmitting device and the proposed receiving device. In addition, a method is proposed as well as a computer program product comprising method steps which is suitable in a production plant for providing the system arrangement or the input device and the output device. Furthermore, a computer-readable medium is proposed comprising the control commands.

### BACKGROUND

US 2013/0101058 A1 shows a multi-protocol interface with a number of components and bidirectional data paths.

Various solutions are known from the state of the art that realize data communication using software. For this purpose, various solutions are from the state of the art, which have components that are implemented either by software or hardware.

A software implementation in particular can result in increased effort and the complexity of the underlying circuits is high. Such applications are aimed at application scenarios that need to be flexible and implement dynamic packet switching, for example.

State-of-the-art methods are typically not suitable for use in an automobile, as they often use proprietary standards that are designed for high-performance computer networks but do not meet the requirements of an automobile. In an automobile, completely different requirements are placed on real-time data transmission and error robustness. Methods relating to the transmission of video data are typically designed for an end user with a powerful computer system. In such application scenarios, large hardware capacities are typically available and energy consumption only plays a subordinate role. In cars, on the other hand, it is necessary to save weight, offer high reliability and save energy. In electromobility, higher energy consumption directly means a lower range of the car. In this respect, there is a need in the state of the art to create devices that create data with little technical effort and in many respects with high efficiency.

All of these technologies listed as examples are optimized for the transmission of one data type (video, audio, SPI, Ethernet). Bridging” from one interface (e.g. Displayport) to another interface with the same data type (e.g. HDMI) is not possible.

At the same time, electronic systems in vehicles have been becoming ever more complex, ever more powerful and ever more “data-intensive” for decades.

The effective and rapid networking of display units, actuators, sensors and processing units plays a central role here, if not the role that determines system performance.

Display units, sensors and actuators and the associated processing units are relatively far apart in a vehicle. If individual communication solutions between sensor/actuator and processing unit (GPU/CPU) are now realized for each interface, as in a PC or mobile phone (state of the art above), this means an immense amount of cabling (weight) with mostly limited performance due to the spatial distance.

In order to save weight on cables and connectors, it is necessary to bundle data connections on one and the same cable system. For one and the same type of data, these are the classic SERDES solutions (state of the art). Systems for transmitting data serially at gigabit data rates.

The bundling of different data paths requires universal, not data type (video, audio, etc.) specific solutions. The multitude of data interfaces, both existing and constantly emerging, must be mapped to standardized, universal interfaces in order to enable the greatest possible re-use of the complex data path logic.

There is therefore a need to create devices, system arrangements and processes that do not realize the disadvantages described above and can be used in a particularly advantageous way in an automobile.

Accordingly, it is a task of the present invention to propose a transmitting device which can be implemented particularly efficiently and also saves hardware resources, especially with regard to use in automobiles. Furthermore, it is a task to propose a receiving device which is partially functionally inverse to the transmitting device, as well as a system arrangement which combines all devices with one another. In addition, it is a task of the present invention to propose a method for providing the devices as well as a computer program product with a computer-readable storage medium.

### SUMMARY

An input device in the transmitting direction for efficiently transmitting data in an automobile is proposed, comprising an input interface device having a plurality of input interface units, with a first group of input interface units which are each set up in terms of hardware for receiving continuous data and a second group of input interface units which are each set up in terms of hardware for receiving discontinuous data; a packetization device arranged for segmenting the data and for enriching the data with forwarding information and data protection information; a packetization device packet data processing device for forwarding the data and an output device arranged in the transmitting direction for providing the data to a physical transmission channel, wherein the input interface device, the packetization device and the output device are unidirectionally communicatively coupled.

The proposed input device in the transmission direction is particularly efficient with regard to the forwarding of data, as the structure of the input device is designed in such a way that data is only forwarded unidirectionally and the device is not designed bidirectionally, as is the case in the prior art. This simplicity in the input device makes it possible to provide the device particularly efficiently and only two types of input interfaces are required. These input interfaces are of different types and are optimized to receive either continuous data or discontinuous data. Furthermore, it is possible to control the packetization device, which can also be referred to as a packet data processing device or packet data processing device, in such a way that only one physical data channel is required. If several data paths are used, it is possible according to the invention to set up to 128 virtual data paths on this one physical data channel. This results in a particularly high level of fault tolerance and a reduction in weight, as it is not necessary to maintain many physical paths, but only a single physical data channel.

The data is forwarded in such a way that the data is received at the input interface device and passed through the input device in the sending direction, multiplexed in the packet data processing device with packet data from other input interface devices and output at the output device in the sending direction. Multiplexing means transmitting several signals or information streams on a line simultaneously in the form of a single, complex signal and then splitting them again into separate signals at the receiving end. According to embodiments of the present invention, packet data from several input interface devices is therefore combined.

Further processing steps can also be carried out when the data is passed through. In particular, it is possible to extract or process the data in the packet data processing device. For example, a packet data processing device can be coupled to the input device, which outputs a corresponding signal.

The input interface device has a large number of input interface units. This means that the input interface device can receive the data for the different virtual channels via several physical data channels, with each virtual channel being assigned to an input interface unit. In general, the input interface device or the input interface unit is implemented in such a way that it is set up to receive continuous data or to receive discontinuous data. The technical difference between these interfaces relates, for example, to the size of the buffer memory or volatile memory provided. In general, there are therefore two groups of input interface units, whereby one group is intended for receiving continuous data and the second for receiving discontinuous data. In general, all data is received via the input interface unit. A continuous data stream can be video data, for example, and discontinuous data can be control commands. According to an aspect of the present invention, the two groups of input interface units may also be differentiated such that the first group provides a faster processing unit than the second group. This allows continuous data to be processed with larger memory and/or faster processing power than is the case when processing discontinuous data.

In addition, a segmentation unit is provided, which is set up to generate data packets, whereby data packet-specific information is provided. This can be information relating to addressing or routing or also to protect the data packet-specific information. The data packet-specific information can be protected, for example, by means of a checksum. According to one aspect of the present invention, data packetization is also controlled here. This means that the application data is formatted to packet data (data cells) and/or the bit width is adjusted.

The subsequent packet data processing unit (crossbar unit) according to one aspect of the present invention supplements the data packet-specific information with forwarding information, which specifies the destination to which the data is to be forwarded. This can be static routing, which in turn is particularly efficient to implement. Dynamic routing would require too much technical effort and the input device could not be implemented efficiently.

Furthermore, according to one aspect of the present invention, an output device (Line Coding & Framer Unit) is provided, which is set up to provide the data to a physical transmission channel. The output device the data from the packet data processing unit (crossbar unit) and is then set up in terms of hardware to output the data. The output can, for example, be transmitted to the proposed output device in the sending direction. For this purpose, the output device is provided with an input device in the sending direction. The output device is implemented in such a way that it processes, outputs and/or provides the packaged data from the packet data processing unit (crossbar unit) to the physical transmission channel. The physical transmission channel can be a cable and the output device also provides an interface for this.

The input interface device (burst data interface, stream data interface), the packetization device (segmentation unit), the packet data processing unit (crossbar unit) and the output device (line coding & framer unit) are connected in such a way that they forward unidirectional data, i.e. the input data from the input interface device is forwarded to the packetization device and the packet data processing unit and can then be output using the output device. A data flow in reverse order is not provided. This makes it possible to implement the proposed input device particularly efficiently.

Embodiments of the invention provide the following advantages, among others:
Modular expandability with application interfaces without changing the data path logic (compliance and compatibility with existing systems remains guaranteed);
Use of any phys with different bandwidths without changing the data path logic (compliance and compatibility with existing systems remains guaranteed);
Hardware solution for customization to any application interface reduces software effort and ensures high, efficient data throughput.

According to one aspect of the present invention, the number of interface units is between 2 and 128 and/or there are up to 128 virtual data paths to the input interface units. This has the advantage that the hardware requirements can be minimized so that only a single physical interface has to be provided and yet 128 virtual data paths can be set up. The number of interface units can also vary, whereby at least one input interface unit of the first group and one input interface unit of the second group must be present. This ensures that both continuous data and discontinuous data can be optimally processed.

According to a further aspect of the present invention, the input interface device, the packetization device, the packet data processing unit and/or the output device are implemented in hardware. This has the advantage that it is not necessary to implement a complex circuit which stores and executes software commands. Instead, the devices can be hard-coded and can therefore be operated efficiently. The devices can be provided with little technical effort, as no dynamic processes need to be processed. This means that all units can be provided hard-wired. This also increases reliability and reduces energy requirements.

According to a further aspect of the present invention, all units and devices only transmit data in one direction. This has the advantage that the structural features can be equipped particularly efficiently. Unidirectional data transmission also ensures that no protective mechanisms need to be provided, since data flow is only possible in one direction. Faulty data can therefore not be transmitted in the opposite direction, which in turn implements a simple protection mechanism.

According to a further aspect of the present invention, continuous data is available as streaming data and discontinuous data is available as burst data. This has the advantage that the hardware can be adapted to the corresponding transmission concept and thus optimized hardware can be provided. The hardware can therefore cater to the special requirements of streaming data or burst data. Streaming data in particular places high demands on real-time transmission, as video data would otherwise be delayed. Mechanisms can also be implemented to ensure that streaming data is transmitted continuously and burst data allows for pauses in data transmission. The buffer memory can then be set up accordingly.

According to a further aspect of the present invention, continuous data can have a frame which segments the continuous data (e.g.: Hsync, Vsync, DE for video) and discontinuous data typically have no frame information, since these have an implicit beginning and end due to the burst-like data structure. In turn, a particularly efficient circuit is realized that provides a logic implemented in hardware for continuous data, which attaches the frame information to the data packets. The same mechanism can optionally be used for discontinuous data to signal the start/end of the burst

According to a further aspect of the present invention, the interface units for continuous data have a larger buffer memory than interface units for discontinuous data. This has the advantage that the memory does not have to be oversized and the interfaces for discontinuous data in particular can be designed to be correspondingly efficient. This in turn reduces the technical effort involved in providing the data.

According to a further aspect of the present invention, the packetization device adapts the format of the data. This has the advantage that further information can be provided, such as an address and/or a checksum to secure the data transmission.

According to a further aspect of the present invention, the input interface device, the packetization device and the output device comprise volatile memories. This has the advantage that efficient memories can be created that do not need to store data persistently. Volatile memories are particularly easy to manufacture and also have a high operating speed.

According to a further aspect of the present invention, the number of interface units of the first group and the second group is the same. This has the advantage that symmetrical processing is possible and thus specialized interface units can be created.

According to a further aspect, however, the number of interface units in the first group and the second group can also vary. This then makes it possible to take the corresponding application scenario into account.

The problem is also solved by an output device in the receiving direction for the efficient forwarding of data in an automobile, comprising an output interface device having a plurality of output interface units, with a first group of output interface units which are each set up in terms of hardware for the transmission of continuous data and a second group of output interface units which are each set up in terms of hardware for the transmission of discontinuous data; a reassembly unit set up for recovering the application data from the packet data, the forwarding information and the data protection information; a crossbar unit and an input device in the receiving direction set up for receiving the data on a physical transmission channel, wherein the output interface device in the receiving direction, the reassembly unit, the packet data processing unit and the input device in the receiving direction are unidirectionally communicatively coupled.

According to one aspect of the present invention, the output device in the receiving direction is analogue to the input device in the transmitting direction with inverse functionality. This therefore means that the output device in the receiving direction provides inverse functionality and the output of the input device in the transmitting direction becomes the input of the output device in the receiving direction. The packaged data of the input device in the sending direction is therefore unpacked in the output device in the receiving direction and output in the inverse direction. In this respect, all aspects of the input device in the sending direction also affect the aspects of the output device in the receiving direction. Data processing or data forwarding takes place in the output device inversely to the direction of the input device.

The problem is also solved by a system arrangement comprising the transmitting device and the receiving device, which are communicatively coupled by means of a serial data connection. The system arrangement can be molded in one piece or the transmitting device and the receiving device can be implemented separately.

According to a further aspect of the present invention, static routing and/or hardwiring is provided between all devices, equipment and units. This has the advantage that the structural features can be designed efficiently and a better runtime behavior is achieved.

According to a further aspect of the present invention, the system arrangement is molded in one piece. This has the advantage that a compact and non-destructive design is created. In this context, one-piece means that the components cannot be separated in a non-destructive manner. This makes it possible to connect or wire the components of the input device and the output device, in particular the input interface device and the output interface device, efficiently and with little technical effort.

According to a further aspect of the present invention, the input interface device and the output interface device have a direct hardwired communicative coupling to each other. This has the advantage that a feedback loop is formed without breaking up the unidirectionality. This makes it possible to carry out a function test without great technical effort.

According to a further aspect of the present invention, a functionality test can be carried out in such a way that identical data is input and then output by means of direct data communication between the input interface device and the output interface device. This has the advantage that the functionality of the devices can be tested in a simple manner. If a data stream is input at the input interface device, it can be output directly at the output interface device via the direct coupling, i.e. without having to pass through other devices. This makes it possible to check whether the data has been passed through correctly. Alternatively, it is not the same data that is expected as output, but the processed input data in order to check whether the processing up to this component has been carried out in accordance with the specification. This results in a simple function test that excludes the other components coupled in series in the data communication by means of the short feedback loop in accordance with the longer data communication.

The problem is also solved by a method of providing an input device for efficiently forwarding data on virtual data paths, comprising providing an input interface device comprising a plurality of input interface units, with a first group of input interface units, which are each hardware-wise set up to receive continuous data, and a second group of input interface units, which are each hardware-wise set up to receive discontinuous data; providing a packetization device and packet data processing unit arranged to enrich the data with forwarding information and data protection information; and providing an output device arranged to provide the data to a physical transmission channel, wherein the input interface device, the packetization device, the packet data processing unit and the output device are unidirectionally communicatively coupled.

One aspect of the present invention is to bundle several data streams (video, audio and data) in a transport frame and transmit them serially. The different data formats not only have different bandwidth requirements, but also different latency and bit error rate requirements. In particular, the transmission of today's video data formats requires not only the transmission of pure video data and its frame information, but also the support of encryption methods such as HDCP. All of this requires many different data channels with a wide range of bandwidth, latency, bit error rate and bit error detection requirements. Added to this is the desire for far more complex network architectures than a simple transmitter/receiver architecture offers. Architectures with several repeaters, where data paths can begin and end, branches (Y) and the possibility of reintegrating data paths into a link are advantageous.

According to one aspect of the present invention, the technology follows the basic idea of bundling the data of the different services, but offers completely new possibilities with regard to network architectures and allows new approaches in the implementation of today's video interfaces. In addition, it can be used as a universal data transport system, for example for transmitting Ethernet or camera data or any type of sensor data.

With a virtual path in embodiments of this invention, all data packets or cells take the same path, in contrast to IP, where a packet could reach its destination via different paths than previous and subsequent packets. Latency over a virtual path is therefore constant.

Virtual paths based on data packets or cells also have the advantage that they can be used as multiplexing layers for different services (video, audio, Ethernet)

Virtual paths only consume bandwidth when data is actually being transferred.

The concept of virtual paths implemented here also makes it possible to realise complex and far-reaching diagnostic and network configuration functions at runtime with separate (virtual) data channels.

According to one aspect of the present invention, an input device in the sending direction, a packet data processing device in the sending direction, an output device in the sending direction, an input device in the receiving direction, a packet data processing device in the receiving direction, an output device in the receiving direction are implemented between the physical serial interface and the various application data interfaces.

According to one aspect of the present invention, these are used to multiplex the various virtual data paths and support more complex architectures with repeaters and branches. This is mainly done in the packet data processing device.

Another aspect of the present invention is an input device in the transmitting direction and an output device in the receiving direction, which performs the conversion of video (stream) or, for example, Ethernet (packet) data into the cells (data packets). This input device in the sending direction and the output device in the receiving direction also comprises the OAM functions for network diagnosis and management.

According to one aspect of the present invention, the technology can be the basis for transmitting a variety of data formats via a serial connection in the car (and elsewhere). It thus forms the basis for a new generation of devices.

The high serial bandwidths make it necessary to define architectures, cell formats and interfaces that enable flexible internal data bus widths, in order to adapt the speed of the internal clock system to the possibilities of the chip technology.

Embodiments of the present invention comprise an input device in the transmitting direction and an output device in the receiving direction, which performs the conversion of video (stream) or e.g. Ethernet (packet) data into or out of the cells (data packets). The present invention further comprises a packet data processing device in the transmitting and receiving direction, which processes the data packets (cells), supplements them, multiplexes or de-multiplexes them with other cells and thus controls the flow of the cells. Furthermore, the present invention comprises an output device in the transmitting direction and an input device in the receiving direction, which advantageously encodes or de-encodes the data packets (cells) for serial transmission, packs them into or unpacks them from a transmission frame and serializes or de-serializes this transmission frame. The serial connection is basically bidirectional. Theoretically, this connection can be realized via a wide variety of media. In practice, two serial differential GBps connections are used.

In the packet data processing devices, the segmented data (cell payload data) of the application interfaces with header, VP identifier and CRC are assembled into complete cells or cells are CRC-checked and the payload is forwarded to the output device in the receive direction. This is also where the multiplexing of the different cell streams of the input device in the transmit direction or the distribution of the cell payloads to the output device in the receive direction according to the VP identifier takes place. (feed-in/feed-out).

According to one aspect of the present invention, multiplexing and demultiplexing of cell streams in repeaters and splitters (forwarding) also takes place in the packet data processing devices.

According to one aspect of the present invention, the task of the input device in the transmission direction is to adapt the data of the application interfaces to the format of the user data field of the cell and to transmit control information to the opposite side or to transmit control information of the opposite side for the adaptation to be used (clock recovery, frame formation).

According to one aspect of the present invention, all virtual data paths are unidirectional, i.e. they start at an initiator at the application interface and end at one or more targets at the application interface.

The virtual data path starts at an initiator and ends at one or more targets. It is realized by the packet data processing devices and performs the following functions on the virtual path:
Multiplexing & de-multiplexing of cells Adding or removing cells from the cell stream
VP translation

The method can be used to control machines that provide the input devices, provide the output devices, provide the packet data processing device and/or provide the system arrangement.

The task is also solved by a computer program product with control commands that implement the proposed method or operate the proposed device.

### BRIEF DESCRIPTION OF THE DRAWINGS

Further advantages, features and details of the invention are apparent from the following description, in which aspects of the invention are described in detail with reference to the drawings. The features mentioned in the claims and in the description may each be essential to the invention individually or in any combination. Likewise, the above-mentioned features and the features further described herein may be used individually or in any combination. Functionally similar or identical parts or components are sometimes provided with the same reference signs. The terms “left”, “right”, “top” and “bottom” used in the description of the embodiments refer to the drawings in an orientation with a normally legible figure designation or normally legible reference signs. The embodiments shown and described are not to be understood as conclusive, but are exemplary in nature for the purpose of explaining the invention. The detailed description serves to inform the skilled person, therefore known circuits, structures and methods are not shown or explained in detail in the description so as not to impede understanding of the present description.

FIG. 1 shows a schematic flowchart of a method of providing an input device according to one aspect of the present invention.

FIG. 2 shows a schematic block diagram of a transmitting device for efficiently forwarding data, according to a further aspect of the present invention, or a schematic block diagram of a receiving device for efficiently forwarding data, according to a further aspect of the present invention; and

FIG. 3 shows a system arrangement comprising the proposed transmitting device and the proposed receiving device according to a further aspect of the present invention.

### DETAILED DESCRIPTION

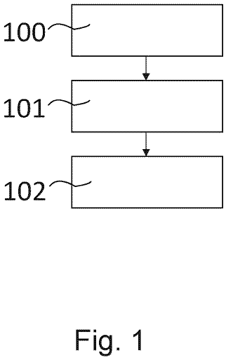

FIG. 1 shows in a schematic flowchart a method for providing an input device for efficiently forwarding data on virtual data paths, comprising providing 100 an input interface device comprising a plurality of input interface units, with a first group of input interface units, which are each hardware-wise set up to receive continuous data, and a second group of input interface units, which are each hardware-wise set up to receive discontinuous data; a provision 101 of a packetizing device arranged to enrich the data with forwarding information and data protection information; and a provision 102 of an output device arranged to provide the data to a physical transmission channel, wherein the input interface device, the packetizing device and the output device are unidirectionally communicatively coupled.

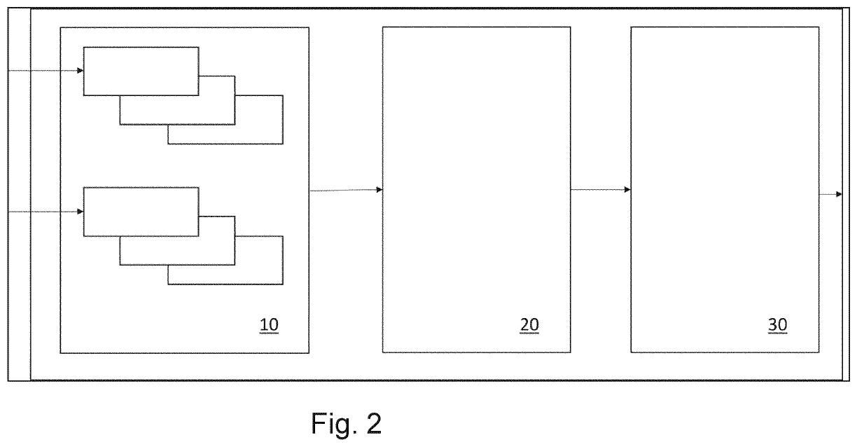

FIG. 2 shows a schematic block diagram of a transmission device for the efficient forwarding of data. The input interface device 10 is shown at the bottom, which has different input interface units, for example the input interface units of the first group on the left and the second group on the right. At the bottom, 6 input arrows are shown representing up to 128 input arrows, which describe virtual paths. The inputs on the bottom are actually implemented via a physical channel. The same applies to the output arrow on the upper side, which can also be implemented as a physical channel. The maximum of 128 virtual paths on the lower side are processed within the input device 10, the packetization unit 20 and the packet data processing device and then output on the upper side with the output device. Further process steps or functionalities can be implemented here. The input interface device 10 forwards the data to the packetization unit 20. These are then output via the output device in the sending direction 30.

FIG. 2 shows a schematic block diagram of a receiving device in an analogue but functionally inverse manner to FIG. 2 for the efficient output of data. The output interface device 10 is shown at the bottom, which has different output interface units, for example the output interface units of the first group on the left and the second group on the right. At the bottom, 6 output arrows are shown representing up to 128 output arrows, which describe virtual paths. The outputs on the bottom are actually implemented via a physical channel. The same applies to the input arrow on the upper side, which can also be implemented as a physical channel. The at most 128 virtual paths on the lower side are processed within the output device 10b, the unpacking unit 20 and the packet data processing device 31 after they have been received from the upper side by the input device 32. Further process steps or functionalities can be implemented here. For example, the output interface device 10b receives the data from the unpackaging unit 20, which is received by the input device in the receiving direction 30.

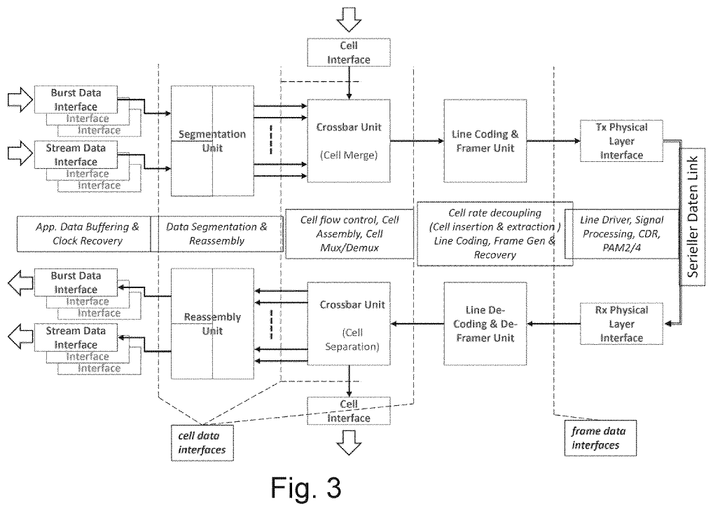

FIG. 3 shows the system arrangement with transmission device at the top, comprising the input device, also referred to as input interface device 10a, in the top left transmission direction, the packet data processing device, also referred to as packetization device 20, in the top center transmission direction, and the output device, also referred to as output device 30, in the top right transmission direction. As can be seen from the present FIG. 3, further functionalities or structural features can be realized in the individual devices. can also be seen from FIG. 3 that the data is forwarded in a strictly unidirectional manner. This creates a universal, modular mass data transport system.

The burst data interface on the left can represent an input interface unit for receiving discontinuous data. The stream data interface may represent an input interface for receiving continuous data. In one aspect of the present invention, the segmentation unit corresponds to the packetization unit. In an aspect of the present invention, the crossbar unit corresponds to the packet data processing device.

The other unit below shows the receiving device consisting of the input device in the receiving direction at the bottom right, the packet data processing device in the receiving direction at the bottom center and the output device in the receiving direction at the bottom left.

At the right-hand edge, a serial data link connects the transmitting device with the receiving device, which can be implemented as a cable or fiber optic cable.

The top three blocks are devices of the transmitting device and the bottom three blocks are devices of the receiving device. The units and devices of the transmitting device are followed by the units and devices of the receiving device via the arrow on the right-hand side. Here again, the data is forwarded unidirectionally and output on the left-hand side via a maximum of 128 virtual data channels.

FIG. 3 shows a direct coupling between the input interface device and the output interface device by means of a filled black arrow. The input interface device at the top and the output interface device at the bottom have a direct hard-wired communicative coupling to each other. This shortens the communication path and this path can be used in a test mode. The components on the right are therefore decoupled from the communication path and the signal is output efficiently with or alternatively without processing in the input interface device or the output interface device by means of the output interface device. This can be a direct hard-wired communicative coupling. This can be implemented efficiently, especially if the system arrangement is molded in one piece.

The structural features shown can be described as follows:

In accordance with one aspect of the present invention, the invention provides generic hardware (burst/stream) solutions for providing data from any application interfaces for transmission using the same data cells. Based on the data cells, the transmission system implements virtual data paths between application interfaces via a serial link. It also offers the option of accessing the virtual data paths directly via a cell interface for the purpose of “repeating” (forwarding the data of a data path without changing the data/cells).

In some embodiments, the invention comprises:
a) Burst Data Interface Input
   a. Application data buffer for burst-type data (PCI, SPI, I2C). Buffering of burst data to enable seamless packaging of the data cells in the segmentation unit.
   b. Formatting of the application data to the cell data bit widths Adaptation.
   c. Transition from the application cycle system to the cell cycle system
   d. Provision of a generic mechanism for marking data packets for the purpose of synchronizing data and control signals of the application interface (e.g.: burst start/end)
b) Burst Data Interface Output
   a. Application data buffer for burst-type data (PCI, SPI, I2C). Buffering of cell data to enable a gapless data burst at the application interface.
   b. Formatting of the cell data to the application data bit widths Adaptation.
   c. Transition from the cell cycle system to the application cycle system with the option of generating the application cycle.
   d. Provision of a generic mechanism for evaluating the marking of the data packets for the purpose of synchronizing data and control signals of the application interface (e.g.: burst start/end)
c) Stream Data Interface Input
   a. Application data buffer for continuous data (video, audio). Buffering of video data to enable seamless packaging of the data cells in the segmentation unit.
   b. Formatting of the application data to the cell data bit widths Adaptation.
   c. Transition from the application cycle system to the cell cycle system
   d. Provision of a generic mechanism for marking data packets for the purpose of synchronizing data and frame signals of the application interface (e.g.: Hsync, Vsync, DE)
d) Stream data Interface Output
   a. Application data buffer for continuous data (video, audio). Buffering of cell data to enable an uninterrupted, continuous data stream at the application interface.
   b. Formatting of the cell data to the application data bit widths Adaptation.
   c. Transition from the cell clock system to the source-synchronized clock system of continuous data with the option of generating the application clock.
   d. Provision of a generic mechanism for evaluating the marking of the data packets for the purpose of synchronizing data and frame signals of the application interface (e.g.: Hsync, Vsync, DE)
e) Segmentation unit/packaging facility
   a. Generation of the data cells with the cell-specific information data for cell routing and cell data protection. Control of cell packaging. (Formatting of the application data to the cell data; bit width adjustment)
f) Reassembly unit/depackaging device
   a. Recovery of the application data aud from the data cells on the basis of the cell-specific information data for cell routing and cell data protection. Control of cell depackaging (formatting of cell data to application data; bit width adjustment)
g) Crossbar Unit for Cell Merge
   a. Receipt of data cells from different ports (burst data interfaces, stream data interfaces, cell interface and assignment of routing information to the cell based on the origin (port).
   b. Multiplexing of all received cells to one output (to the line coding and framer unit)
   c. Control of the latency time of the cell streams via a configurable arbitration mechanism based on priority.
h) Crossbar Unit for Cell Separation
   a. Output of the data cells to various ports (burst data interfaces, stream data interfaces, cell interface based on the routing information of the cells.
   b. De-multiplexing of all received cells (from the line de-coding and de-framer unit) to many outputs.
i) Line Coding & Framer Unit
   a. Adaptation of the cell data rate to the link data rate by inserting empty cells.
   b. Coding of the data for serial data transmission
j) Line De-Coding & De-Framer Unit
   a. De-coding the serial data
   b. Removal of empty cells.
k) Tx Physical Layer Interface
   a. Conversion of parallel data into serial data.
   b. Translation of the serial data bits into electrical or optical signals.
l) Rx Physical Layer Interface
   a. Translation of electrical or optical signals into serial data bits.
   b. Conversion of serial data into parallel data.

Not shown here is a data memory or a computer-readable medium with a computer program product comprising control commands which implement the proposed method or operate the proposed system arrangement.

### The Physical Layer Interface (Tx and Rx)

### Purpose and Function

The physical layer interface realizes the electrical connection with the physical transmission medium. The primary transmission medium is a differential 100 ohm line. However, optical transmission media can also be considered as an option.

The physical transmission format depends on the data rate and is either NRZ for low data rates or PAM4 for high data rates.

The Physical Layer Interface function block implements the serialization of the M-bit-parallel line-coded data (M=raw serializer bit width) on the transmitting side and the recovery of the serial clock and the bit-serial data as well as the deserialization to M-bit-parallel line-coded words on the receiving side. Serial data transmission is based on the concept of the “embedded clock”, i.e. no time is transmitted, only serial data, which enables time recovery due to the line coding.

The cell clock frequency is mainly determined by the “raw bit width” M of the SERDES. At 30 GBps and a raw bit width of M=128, for example, this results in a core clock frequency of 234.375 MHz.

### Interface to the Physical Medium

In the direction of the transmission medium, the physical layer interface function block according to one aspect of the present invention implements two unidirectional, differential, bit-serial 100 ohm interfaces. One transmit and one receive interface. The physical medium comprises a differential forward line and a differential return line throughout. This arrangement also enables the optional operation of optical media without major adaptation circuits.

For the physical medium, the focus is on twisted pair cables, as the insertion loss of coaxial cables at higher frequencies is equal to the insertion loss of twisted pair cables. If the 6 dB attenuation of single-ended transmission compared to differential transmission is taken into account, there is absolutely no advantage left for coaxial cables.

The maximum cable length depends on the data rate (and the cable diameter).

According to one aspect of the present invention, a bit clock system for serializing the data is generated in the transmission direction with the aid of a PLL. The data/symbols are sent with this bit clock. The bit clock forms the basis for the Tx clock system. The Tx data path is directed in the opposite direction to this clock system. (target synchronized)

In the receive direction, the bit clock used to serialize the data is recovered from the received serial data stream using a CDR. This bit clock forms the basis for the Rx clock system. The Rx data path is directed in the same direction as this timing system (synchronous source).

The core clock frequency can mainly be determined by the “Raw Bit Width” M of the SERDES. At 30 GBps and a raw bit width of M=128, for example, this results in a core clock frequency of 234.375 MHz. As SERDES technologies can vary, M will also vary. Consequently, the cell format and the cell data interfaces between the various functional units or devices must support flexible SERDES bit widths, or the cell format must be decoupled from the cell line data width.

### Line Coding & Framer Device and Line Decoding & Deframer Device

### Purpose and Function

According to one aspect of the present invention, the output device in the

transmitting direction or the input device in the receiving direction generates the M-bit wide symbols of the line code for the SERDES interface from the N-bit wide transmission frames (see: 7. Transmission frames and cell format) in the transmitting direction and generates the N-bit wide transmission frames again from the M-bit symbols of the SERDES interface in the receiving direction.

The main function of the output device in the transmitting direction and the input device in the receiving direction is to assemble the transmission frames from the cells in the transmitting direction and, conversely, to disassemble the transmission frames into cells in the receiving direction.

In order to adapt the data rate of the cell stream to the data rate of the serial transmission, these devices can insert empty cells in the transmission direction (from the application interface to the serializer) in accordance with one aspect of the present invention. The availability of cells depends on the total bandwidth requirements of all application interfaces. Thus, according to an aspect of the present invention, the cells do not form a continuous flow of cells as the cells are processed (collected, assembled and merged) with the system clock.

In the receive direction (from the deserializer to the application interfaces), the empty cells are discarded here. The cells are extracted from the serial frame. As the cell data rate is lower than the bandwidth in relation to the system clock, as in the send direction, these cells are forwarded with a data validity signal.

The packet data processing device handles the flow of cells. In addition to the generation of cell headers and CRCs or the extraction with CRC check of the data from the cells, a so-called add-drop multiplexer function is implemented here.

This means that in the sending direction, the cells are collected by the various service functions, provided with a VP identifier, cell header and footer are generated and collected by the peer-to-peer interface and then multiplexed into a common cell stream (add function).

In the receive direction, according to one aspect of the present invention, the cell stream is distributed from the input device in the receive direction to the various service functions and the peer-to-peer interface according to the VP identifier. The data for the service functions is unpacked and CRC-checked (drop function). All cells whose VP identifier does not belong to a service function are forwarded to the peer-to-peer interface (forward function).

### Input Device in Transmitting Direction and Output Device in Receiving Direction

### Purpose and Function

Here, the virtual data paths based on cells are converted back into physical data paths. These are connected to the various application interfaces via generic service interfaces for stream or burst data.

Application interface types are, for example, stream data for video and audio data and burst data for almost all types of packets. The way in which stream and/or burst data is packed or unpacked to/from the cells is not coded in the cell. Instead, it is configured between two endpoints or agreed based on a virtual connection.

In the sending direction, the input device together with the application-specific interface according to one aspect of the present invention implements the starting point for the cell-based virtual data paths.

In the receiving direction, the output device together with the application-specific interface implements the end point for the cell-based virtual data paths.

One of the main tasks of these devices (together with the application-specific interfaces) is to enable the format conversion (bit width) of streamed or burst data with any bit width into the N-bit wide cell line data format.

The interfaces between the stream data or burst data functions to these two devices have the bit width of the cell rows (N). The stream data or burst data interfaces combine the clock domain traversal and the bit width conversion of the data from the application interface to the N bits of the cell rows. The cell line payload is already formatted so that the cell footer and header fit into the first and last cell line.

According to one aspect of the present invention, the cells offer the possibility of transmitting payload information data in addition to payload data. The payload information data is used, for example, to generate frame signals for video or audio in the case of stream data and to generate packets, transactions or bursts in the case of burst data.

### Binding Frame Signals to the Streaming Data

The basic idea of connecting frame signals to the data stream is to define a significant anchor point (or several anchor points) in the time sequence of the frame signals and to transmit this (or these) using the payload info bits so that clear synchronization of the data stream and frame signals is possible. Ideally, this is done by placing a fixed point of the data stream at a fixed point in the marked data cell. To restore the timing of the frame signals, a free-running timing generator is used, which can generate the entire timing independently. The timing is now adapted to the data stream by analyzing the payload info bits and adapting the timing to the defined point in the data cell.

### Stream Data (Continuous Data Stream)

The stream data interface combines the transition from the application clock domain to the cell clock domain and the conversion of the bit width of data from the application interface to the N bits of the cell rows. The cell row payload is already preformatted so that the cell footer and header fit into the first and last cell row.

Streaming data is (normally) source-synchronized. The clock domain crossing of the data path from the application clock domain to the cell clock domain is performed here.

A data buffer is provided in the sending direction, into which the source-synchronized data is written with the application clock. The input device in the transmitting direction retrieves the data from this buffer as required in order to perform the data format conversion into the N-bit wide rows of the cells. Frame signals (e.g.: Hsync, Vsync, DE) are encoded in payload info bits so that the frame signals can be reconstructed on the receiver side.

In the receive direction, the cell data is written to a data buffer by the output device in the receive direction. The frame signals are reconstructed based on the payload info bits. The application clock on the transmit side is regenerated, for example, using buffer fill level and clock synthesis.

If data encryption is required (HDCP), the cell data is encrypted or decrypted in this function.

Due to the different types of stream data, such as: Audio, video with and without encryption, there may be different implementations of this basic function (e.g.: VStream In/Out; AStream In/Out; EncVStream In/Out).

### Burst Data (Discontinuous Data Stream)

The burst data interface combines the overflow from the application clock domain to the cell clock domain and the conversion of the bit width of burst data from the application interface to the N bits of the cell rows. The cell row payload is already preformatted so that the cell footer and header fit into the first and last cell row.

Burst data is (normally) synchronized to an external clock and has different identification signals for direction and data type (address/data/ByteEnable).

This data is normally accompanied by control lines in order to realize a specific protocol.

A data buffer is provided in the sending direction, into which the burst data is written with the interface clock. The input device in the transmitting direction retrieves the data from this buffer as required in order to perform the data format conversion into the N-bit wide row cells.

In the receive direction, the cell data from the output device is written to a data buffer in the receive direction. The interface control signals are reconstructed based on the payload info bits.

The payload info bits are used to generate the control signals of the application-specific interfaces or to synchronize the protocol state machines in the application-specific interfaces.

Due to the different interfaces that provide burst-like data (SPI, I2C, MII), there may be different implementations of this basic function (e.g.: SPIBurst, I2CBurst, MIIBurst).

Accordingly, there will also be (slightly) different stream in/out interfaces, although their structure should be the same.

### The Cell Format

According to one aspect of the present invention, the cell comprises a

header with a fixed bit length, a payload area with 4 selectable bit lengths and a footer, again with a fixed bit length.

The cell structure is a sequence of bits as follows:
A 7-bit virtual path identifier (VP) that represents a unique address of the virtual path.
A 3-bit sequence number (SN) that numbers the cells consecutively in their sequence.
A 2-bit wide cell type (CT) identifier that specifies the length of the user data.
A 3-bit wide payload information (PI) that contains additional information about the payload. This can also be used to synchronize payload data and frame data or control data.
A 10-bit wide CRC polynomial (HCRC) for error protection of the header information. The polynomial has a Hamming distance of 5 up to a bit sequence of 21 bits (P=0x2B9).
The payload (PL) range has a length of: 187, 411, 635 or 859 bits, depending on the CT value. The shortest payload is selected so that it is still larger than the largest supported (video) streaming bus width. (Should simplify the mapping of streaming data to the cell payload).
Finally, a 12-bit wide CRC polynomial (PCRC) for error protection of the user data. The polynomial has a Hamming distance of 4 up to a bit sequence of 2035 bits (P=0x8F3).

### Format of the Transfer Frames

According to one aspect of the present invention, the transmission frame comprises a sequence of M-bit wide words. The frame starts with an M-bit wide “comma” word from a defined sequence of comma words for the frame alignment. This is followed by K cells. The cells consist of 2, 4, 6 or 8 N-bit wide words that carry the header, payload and footer. These N-bit wide words are coded into M-bit wide symbols (line coding).

What is claimed is:

1. A transmitting device for the efficient forwarding of data in an automobile, comprising:
an input interface device (10) having a plurality of input interface units, with a first group of input interface units which are each set up in terms of hardware to receive continuous data and a second group of input interface units which are each set up in terms of hardware to receive discontinuous data;
a packetizing device (20) arranged to enrich the data with forwarding information and data protection information; and
an output device arranged in the transmitting direction (30) for providing the data to a physical transmission channel, wherein the input interface device (10), the packetizing device (20) and the output device (30) are unidirectionally communicatively coupled.

2. The transmitting device of claim 1 wherein the number of interface units is between 2 and 128 and/or there are up to 128 virtual data paths to the input interface units.

3. The transmitting device of claim 1 wherein the input interface device (10), the packetizing device (20) and the output device (30) are implemented in hardware.

4. The transmitting device of claim 1 wherein all units and devices are set up to transmit data in one direction only.

5. The transmitting device of claim 1 wherein continuous data are present as streaming data and discontinuous data are present as burst data.

6. The transmitting device of claim 1 wherein the interface units for continuous data have a larger buffer memory than interface units for discontinuous data.

7. The transmitting device of claim 1 wherein the packeting device (20) adapts the data in its data format.

8. The transmitting device of claim 1 wherein the input interface device (10), the packetizing device (20) and the output device (30) have volatile memories.

9. The transmitting device of claim 1 wherein the number of interface units of the first group and the second group is the same.

10. A receiving device for efficient forwarding of data in an automobile, comprising:
an output interface device (10) having a plurality of output interface units, with a first group of output interface units which are each set up in terms of hardware for transmitting continuous data and a second group of output interface units which are each set up in terms of hardware for transmitting discontinuous data;
a depacketizing device (20) arranged to separate the data from a forwarding information and a data protection information; and
an input device arranged in the receiving direction (30) for receiving the data on a physical transmission channel, wherein the output interface device (10), the unpackaging device (20) and the input device (30) are unidirectionally communicatively coupled.

11. A system arrangement comprising the transmitting device of claim 1 and a receiving device for efficient forwarding of data in an automobile, the receiving device comprising:
an output interface device (10) having a plurality of output interface units, with a first group of output interface units which are each set up in terms of hardware for transmitting continuous data and a second group of output interface units which are each set up in terms of hardware for transmitting discontinuous data;
a depacketizing device (20) arranged to separate the data from a forwarding information and a data protection information; and
an input device arranged in the receiving direction (30) for receiving the data on a physical transmission channel, wherein the output interface device (10), the unpackaging device (20) and the input device (30) are unidirectionally communicatively coupled,
wherein the transmitting device and the receiving device are communicatively coupled by means of a serial data connection.

12. The system arrangement of claim 11 wherein static routing and/or hardwiring is provided between all devices, equipment and units.

13. The system arrangement of claim 11 wherein it is formed in one piece.

14. A method of providing an input device for efficiently routing data on virtual data paths, comprising:
a provision (100) of an input interface device having a plurality of input interface units, with a first group of input interface units which are each set up in terms of hardware to receive continuous data and a second group of input interface units which are each set up in terms of hardware to receive discontinuous data;
providing (101) a packetizing device arranged to enrich the data with forwarding information and data protection information; and
providing (102) an output device arranged to provide the data to a physical transmission channel, wherein the input interface device, the packetizing device and the output device are unidirectionally communicatively coupled.

15. A method for providing the system arrangement of claim 11 comprising providing the transmitting device and the receiving device which are communicatively coupled.

16. A computer program product comprising instructions in a non-transitory computer-readable storage medium which, when the program is executed by at least one computer, causes the computer to perform the steps of the method of claim 14.
